(19) United States
(12) Patent Application Publication
(10) Pub. No.: US 2009/0089491 A1
(43) Pub. Date: Apr. 2, 2009

(54) SEMICONDUCTOR MEMORY DEVICE AND DATA MANAGEMENT METHOD USING SEMICONDUCTOR MEMORY DEVICE

(75) Inventors: Koujiro HATANAKA, Kawasaki-shi (JP); Hikaru Kuriyama, Kawasaki-shi (JP); Koji Ohishi, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/240,258

(22) Filed: Sep. 29, 2008

(30) Foreign Application Priority Data
Sep. 28, 2007 (JP) 2007-253577

(51) Int. Cl. G06F 12/00; G06F 12/02; G06F 12/06

(52) U.S. Cl. 711/103; 711/170; 711/E12.001; 711/E12.002; 711/E12.008; 711/E12.078

(57) ABSTRACT

A semiconductor memory device comprises: a memory part which has a plurality of memory blocks having a memory cell capable of storing a plurality of different kinds of data which require a memory area having different characteristics, and a memory controller which has a function of treating each of the memory blocks as a deletion unit in order to manage the memory part and converting a logic address of the memory part to a physical address identifying the memory block, and which replaces the memory block with a preregistered free block in rewriting the memory block. The memory controller manages the different kinds of data to be stored in the memory part so as to store the same kind of data as before, even after each of the memories and free blocks in the memory part are rewritten.

### CROSS-REFERENCE TO RELATED APPLICATIONS

This application is based upon and claims the benefit of priority from the prior Japanese Patent Application No. 2007-253577, filed on Sep. 28, 2007, the entire contents of which are incorporated herein by reference.

### BACKGROUND OF THE INVENTION

1. Field of the Invention

The present invention relates to a semiconductor memory device and a data management method using the semiconductor memory device, wherein the a semiconductor memory device comprises a memory part for storing data and a memory controller for controlling the reading/writing to the semiconductor memory device.

2. Description of the Related Art

A NAND type flash memory is well known as an electrically rewritable nonvolatile semiconductor memory (EEPROM). The NAND type flash memory has a smaller unit cell area than a NOR type flash memory and it is easy to increase a storage capacity. In addition, the cell unit memory reading/writing speed in the NAND type flash memory is slower than in the NOR type flash memory, however, practical reading/writing speeds can be increased by increasing the cell range (the physical page length) in which reading/writing is performed concurrently between the cell array and the page buffer.

By utilizing these characteristics, the NAND type flash memory has been used to form various kinds of recording media including memory cards and file memories.

In a memory card and the like, a nonvolatile memory and a memory controller are packaged to control the reading/writing of the nonvolatile memory with a command and a logic address provided from a host. For example, reading data in a plurality of sectors by providing the logic address and the number of sectors from the host has been proposed (see Japanese Patent Publication No. 2006-155335A).

On the other hand, the NAND type flash memory erases data in a memory block unit consisting of 128 KB cells, 256 KB cells or the like. Therefore, when a rewrite instruction occurs to a written memory cell, or when data which are a part of a memory block are erased, data in the other memory cells in the memory block where the intended memory cell is to be included need to be temporarily copied to another memory block, then the entire memory block is erased in order to perform operations such as re-writing or additional writing.

Therefore, during initialization, a part of available memory blocks are registered as free blocks except the memory blocks arbitrarily allocated to user blocks as well as system blocks. When additional writing or partial deletion needs to be performed to a user block, a new write block is allocated from the registered free blocks in order to perform copying, additional writing, and the like. The written block is then replaced with the user block and the user block turned to unnecessary block is re-registered as a free block. The memory block which was re-registered as a free block is erased and set to be in a stand-by state for the next usage.

In this type of write control, there is no problem in so far as the same reliability is requested in each memory cell, but, for example, with a plurality of storage areas whose request levels are different, such as a multi-valued data storage area or a binary data storage area, blocks to be used are mixed across a plurality of storage areas and the reliability of the NAND cell is deteriorated accordingly.

### SUMMARY OF THE INVENTION

In one embodiment of the present invention, a semiconductor memory device comprises a memory part which has a plurality of memory blocks having a memory cell capable of storing a plurality of different kinds of data which require a memory area having different characteristics, and a memory controller which has a function of treating each of the memory blocks as a deletion unit in order to manage the memory part and converting a logic address of the memory part to a physical address identifying the memory block, and which replaces the memory block with a preregistered free block in rewriting the memory block, wherein the memory controller manages the different kinds of data to be stored in the memory part so as to store the same kind of data as before, even after each of the memories and free blocks in the memory part are rewritten.

In the other embodiment of the present invention, a semiconductor memory device comprises a memory part which has a plurality of memory blocks having a memory cell capable of storing data in a plurality of different kinds of writing/reading manners which require a memory area having different characteristics, and a memory controller which has a function of treating each of the memory blocks as a deletion unit in order to manage the memory part and converting a logic address of the memory part to a physical address identifying the memory block, and which replaces the memory block with a preregistered free block in rewriting the memory block, wherein the memory controller manages the different kinds of data to be stored in the memory part so as to store each of the memory blocks and free blocks in the memory part in the same writing and reading manner as before, even after rewriting.

In one embodiment of the present invention, a data management method uses a semiconductor memory device, the device comprising a memory part which has a plurality of memory blocks having a memory cell capable of storing a plurality of different kinds of data which require a memory area having different characteristics, and a memory controller which has a function of treating each of the memory blocks as a deletion unit in order to manage the memory part and converting a logic address of the memory part to a physical address identifying the memory block, and which replaces the memory block with a preregistered free block in rewriting the memory block, wherein the different kinds of data to be stored in the memory part are managed by the memory controller so as to store the same kinds of data as before, even after each of the memory blocks and free blocks in the memory part are rewritten.

### BRIEF DESCRIPTION OF THE DRAWINGS

FIG. 1 is a diagram illustrating an LBA-NAND memory system configuration according to one embodiment of the present invention.

FIG. 2 is a diagram illustrating a memory cell array configuration of the LBA-NAND memory.

FIG. 3 is a diagram illustrating a data storage area in the LBA-NAND memory.

FIG. 4 is a diagram illustrating an example of the various kinds of data storage amounts in the LBA-NAND memory.

FIG. 5 is a diagram illustrating one example of a memory block configuration of the LBA-NAND memory and its allocation to each area.

FIG. 6 is a diagram conceptually illustrating the relationship between a logic address space and a NAND block address.

FIG. 7 is a diagram illustrating another example of the conceptual relationship between the logic address space and the NAND block address.

FIG. 8 is a diagram schematically illustrating LBA-NAND memory block management relating to the first embodiment.

FIG. 9 is a diagram schematically illustrating LBA-NAND memory block management relating to the second embodiment.

FIG. 10 is a timing chart illustrating the set-up procedures of a binary data storage area SDA in the LBA-NAND memory.

FIG. 11 is a diagram illustrating an example of a data storage area configuration in the LBA-NAND memory.

### DETAILED DESCRIPTION OF THE EMBODIMENTS

Embodiments of the semiconductor memory device of the present invention will now be described in detail with reference to the drawings.

### [Semiconductor Memory Configuration]

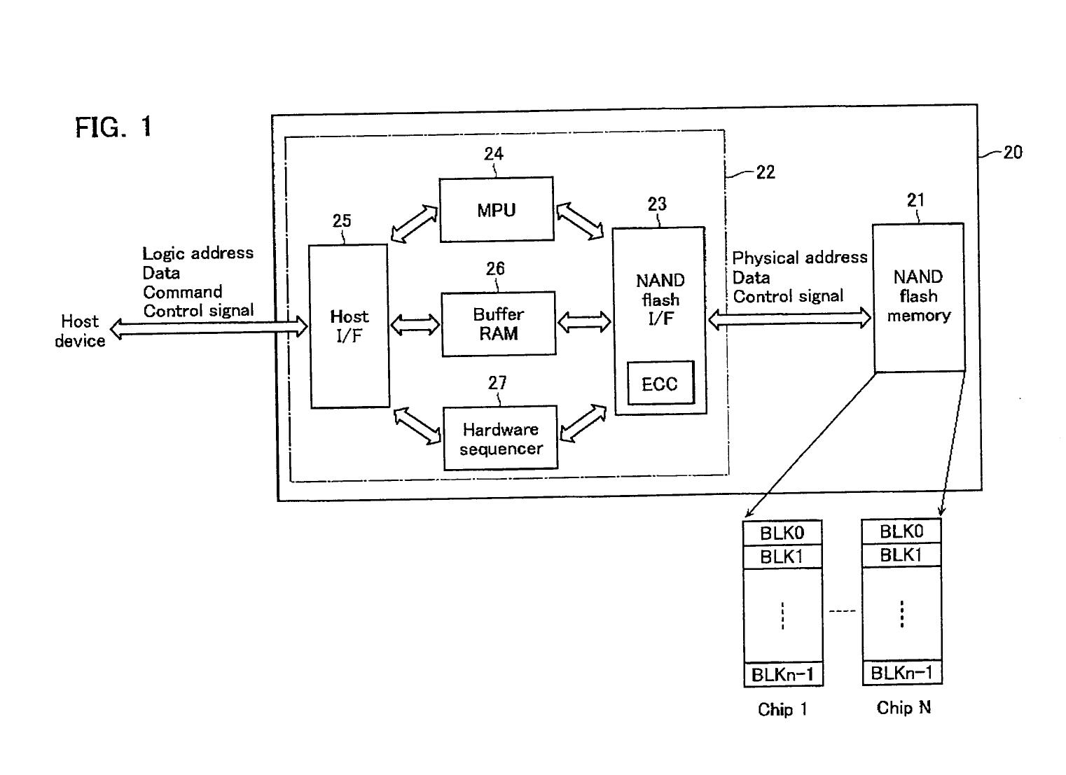

FIG. 1 is a block diagram illustrating a semiconductor memory of the present embodiment.

The semiconductor memory of the present embodiment consists of a memory module, for example, which are packaged into one unit comprising one or more NAND flash memories 21 and a memory controller 22 for controlling the reading/writing of the memories 21. All of the installed flash memories 21 are controlled as logic memories by one memory controller 22, and this is therefore called as a “logic block address of a NAND flash memory” (hereinafter referred to as an “LBA-NAND memory”).

The NAND flash memory 21 to be installed in the LBA-NAND memory 20 consists of one or more memory chips. FIG. 1 illustrates N numbers of sets of memory chips of chip 1, to chip N, and even in the case of chip N, the memory is controlled by one memory controller 22. The maximum number of memory chips to be installed is determined by the current capacity of a regulator and other factors.

The memory controller 22 is a one-chip controller which comprises of a NAND flash interface 23 which exchanges data with a flash memory 21, a host interface 25 which exchanges data with a host device, a buffer RAM 26 which temporarily storages data for reading/writing and the like, an MPU 24 for controlling data exchange, and a hardware sequencer 27 which is used for controlling reading/writing sequences of any firmware (FW) within the NAND flash memory 21 and the like.

Whether the NAND flash memory 21 and the memory controller 22 are combined into one chip or are separated is not essential for this type of LBA-NAND memory 20.

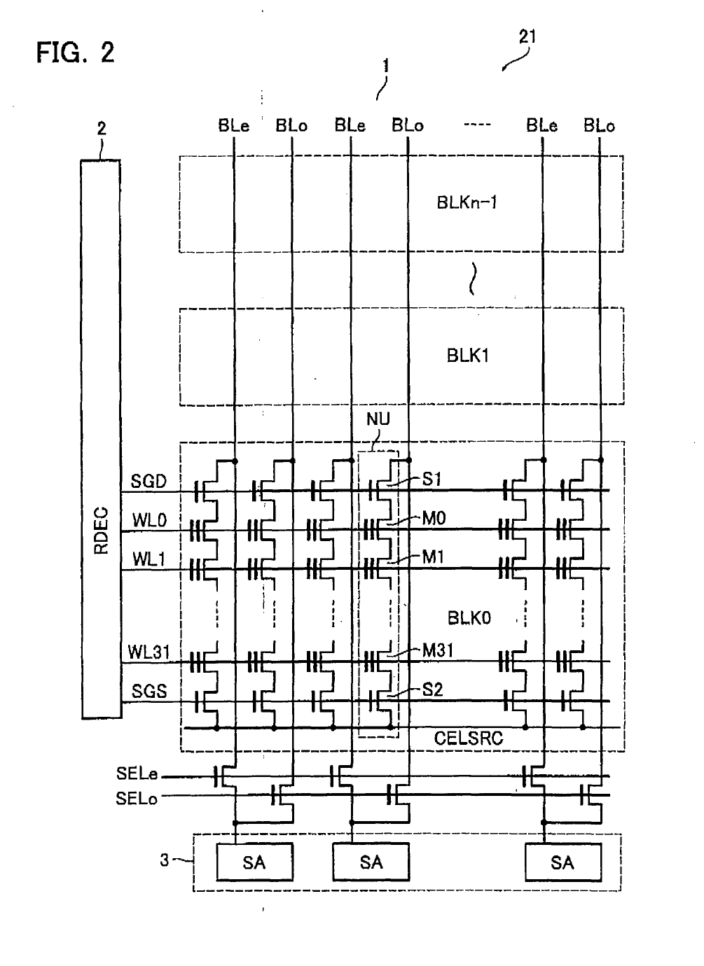

FIG. 2 illustrates a cell array configuration of a memory core part in the NAND flash memory 21 shown in FIG. 1.

A memory cell array 1 is configured by arranging NAND cell units (NAND strings) NU in which a plurality of electrically rewritable nonvolatile semiconductor memory cells (32 sets of memory cells in the example shown in FIG. 2) M0-M31 are connected in series.

One end of the NAND cell unit NU is connected to bit lines BLo and BLe via a selective gate transistor S1, while the other end is connected to a common source line CELSRC via a selective gate transistor S2. The control gates of the memory cells M0-M31 are connected to word lines WL0-WL31, respectively, while gates for selective gate transistors S1 and S2 are connected to selective gate lines SGD and SGS.

A group of NAND cell units to be arranged in the word line direction consist of a memory block which is determined to be the smallest unit for data deletion, and a plurality of memory blocks BLK0-BLKn-1 are arranged in the bit line direction, as shown in FIG. 2.

On one end of the bit lines BLe and BLo, a sense amplifier circuit 3 to be used for cell data reading/writing is arranged, while on one end of the word line, a raw decoder 2 is arranged for selecting and driving the word line and the selective gate line. FIG. 2 illustrates a case in which adjacent even bit line BLe and odd bit line BLo are connected to each sense amplifier SA in the sense amplifier circuit 3 selectively by a bit line selective circuit.

In the LBA-NAND memory 20 configured as detailed above, an external control signal such as a command, an address (a logic address) and data, as well as a chip enable signal/CE, a write enable signal/WE, a read enable signal/RE, a ready/busy signal RY/BY, and the like are inputted to a host I/F 25. The host I/F 25 allocates a command and a control signal to an MPU 24 and a hardware sequencer 27 as well as storing an address and data to a buffer RAM 26.

A logic address inputted from the outside is converted to a physical address of the NAND flash memory 21 at a NAND flash I/F23. Under the hardware sequencer 27's control, based on various kinds of control signals, data exchange as well as the sequences of writing/deletion/reading are controlled. The converted physical address is transferred to the raw decoder 2 or to a column decoder (not illustrated) via an address register in the NAND flash memory 21. Written data are loaded to the sense amplifier circuit 3 via an I/O control circuit and the like, while read data are outputted to an external location via the I/O control circuit and the like.

[Memory area]

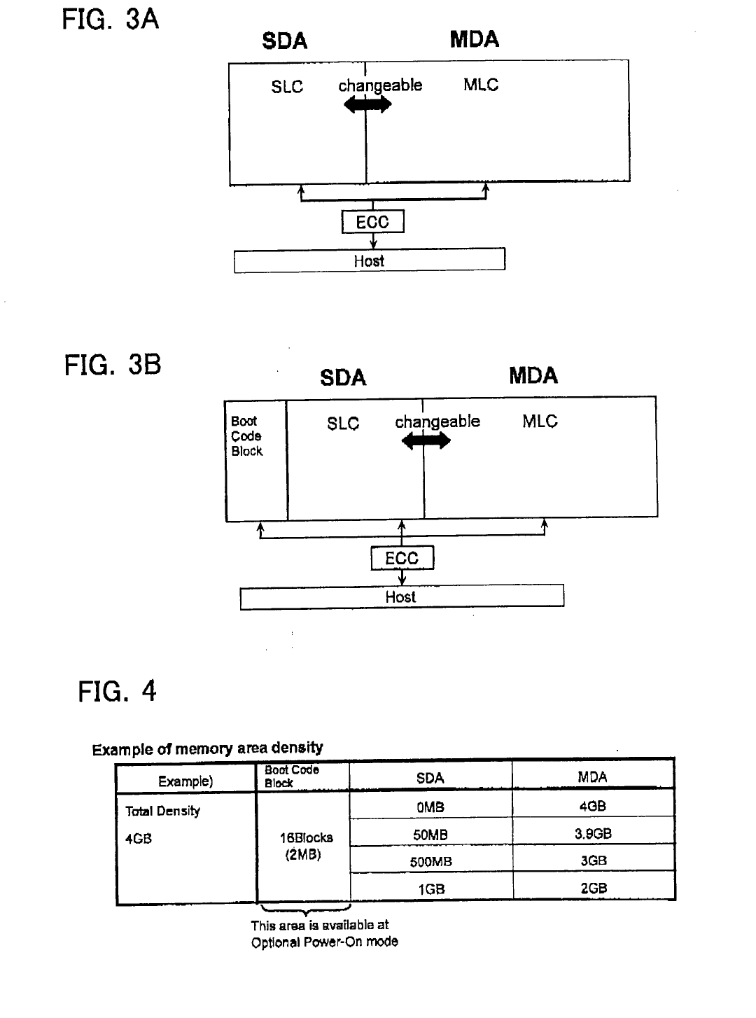

FIG. 3 illustrates details of a memory area in the LBA-NAND memory of the present embodiment.

The LBA-NAND memory 20 in the present embodiment has a plurality of data areas (logic block access areas) capable of switching accesses with a command. In this embodiment, there are two or three specific data storage areas which can be divided according to their usage and data reliability.

In the standard operation mode illustrated in FIG. 3A, each LBA-NAND memory 20 has two data storage areas storing information having different characteristics. One data storage area is a binary data storage area SDA (an SLC Data Area) using a Single Level Cell (SLC), while the other is a multi-valued data storage area MDA (MLC Data Area) using a Multi Level Cell (MLC). The binary data storage area SDA is suited to storing log data and the like for a file system or network communication system, while the multi-valued data storage area MDA is suited to storing music, images and various kinds of applications, and the like.

In the optional power-on mode illustrated in FIG. 3B, in addition to the above detailed two data storage areas SDA and MDA storing information having different characteristics, a boot code block storing a boot code is arranged on top of the memory area.

In these two modes, the boundary between the binary data storage area SDA and the multi-valued data storage area MDA is arbitrarily changeable with a command instruction. For example, with a memory in which a memory cell array capable of using an MLC (4-value) as an SLC (binary) is used and the entire storage amount is 4 GB when the entire memory area is treated as an MLC, if the storage amount of a binary data storage area SDA is configured to be 0 MB, 50 MB, 500 MB and 1 GB respectively, the storage amount of the multi-valued data storage area MDA becomes 4 GB, 3.9 GB, 3 GB and 2 GB, respectively.

### [The First Embodiment of Memory Block Management]

Next, the memory block management of a semiconductor memory device of the first embodiment of the present invention will be explained in detail with reference to the drawings.

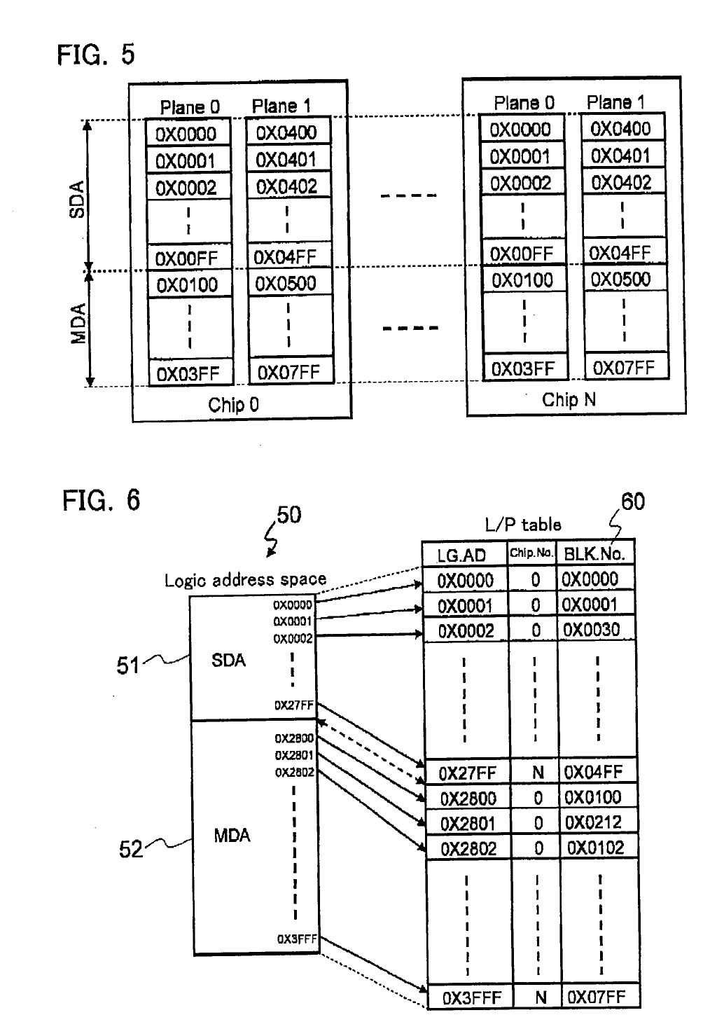

FIG. 5 is a diagram illustrating a memory block configuration of a NAND flash memory 21, which is a memory part having a two-plane constitution. Memory chips 0-N respectively have a plurality of memory blocks in which block numbers 0x0000 to 0x07FF (where “0x” indicates it is a hexadecimal numeral) are given as physical addresses via planes 0 and 1. A memory controller 22 allocates a memory area comprising, for example, memory blocks having block numbers 0x0000 to 0x00FF and 0x400 to 0x4FF as an SDA, and a memory area comprising a memory block having block numbers 0x0100 to 0x03FF and 0x500 to 0x7FF as an MDA during an initialization process based on the aforementioned SDA and MDA's boundary setting commands.

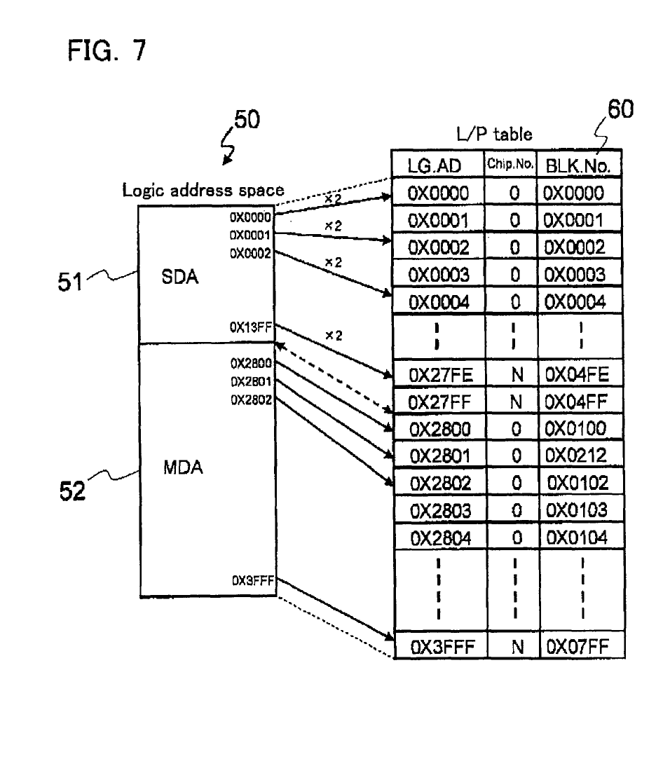

Specifically, as illustrated in FIG. 6, a logic address space 50 is divided into an SDA area 51 and an MDA area 52 in order to create a logic/physical address conversion table (hereinafter referred to as an “L/P table”) 60. This L/P table 60 associates a logic address in a logic address space with a physical address in the NAND flash memory. In this example, logic addresses “0x0000” to “0x27FF” are allocated to the SDA area 51, while logic addresses “0x2800” to “0x3FFF” are sequentially allocated to the MDA area 52. Each logic address and a corresponding physical address are registered to the L/P table 60. In FIG. 6, in order to simplify the explanation, one logic address corresponds to one physical address in the SDA area 51 and MDA area 52, but in practice, for example, if 128 KB is allocated to one memory block identified by one logic address in the SDA area 51, 256 KB, being twice as much as the SDA, is stored in one memory block identified by one logic address in the MDA (for example, 4-value) area 52. Therefore, in the MDA area 52, an address range for one memory block needs to be set to be twice as large as that for the SDA area 51. In order to further simplify the process, for example, as illustrated in FIG. 7, the L/P table 60 itself may be registered as having MDA areas 52 for all of its areas, and when the SDA area 51 is accessed, its logic address is doubled in order to refer to the L/P table 60, or, although they are not illustrated in the drawing, the L/P table 60 is registered in terms of the SDA area 51 and when the MDA area 52 is accessed, an address is halved in order to refer to the L/P table 60.

The division of the SDA area 51 and MDA area 52 are not limited to two. For example, when the MDA includes an MLC such as a 4-value, 8-value, or 16-value or the like, the MDA area may be divided into the number corresponding to that value. These logic address spaces 50 may be arbitrarily determined with a command as described above.

A memory block registered to the L/P table 60 is a deletion unit. In NAND type flash memory, when data need to be rewritten, or when some data in a memory block need to be rewritten, the entire memory block needs to be erased in order to rewrite the data, and data which does not need to be rewritten need to be temporarily copied to the other memory block before that block is erased.

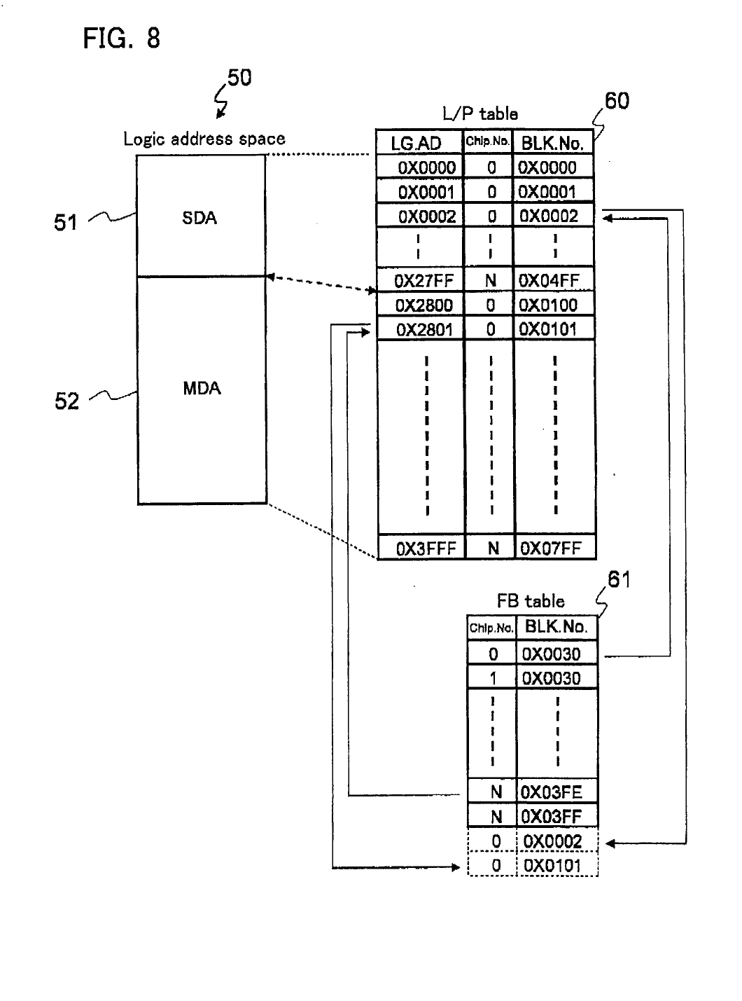

In order to simplify these processes, the memory controller 22 during an initialization process creates a free block table (hereinafter referred to as “an FB table”) 61 in which some memory blocks have been registered as free blocks, as illustrated in FIG. 8, at the same time as the above-mentioned L/P table 60. A free block which is registered to this FB table 61 is excluded from the L/P table 60.

It should be noted that the aforementioned SLC can typically be written/erased up to hundreds of thousand of times, but an MLC can be written/erased up to tens of thousand times only. This is because, in the case of the MLC, a voltage needs to be applied to move a threshold several times when writing into one memory cell, and the voltage to be applied has to be higher than the SLC's voltage. Therefore, when a block which was used as an SLC is used as an MLC, or conversely, when a memory block which was used as an MLC is used as an SLC repeatedly, its cell performance deteriorates, and ensuring the reliability of the entire memory becomes difficult. In particular, when a block which was used as an MLC is used as an SLC, the number of writing/erasing processes which is guaranteed by the SLC cannot be secured.

Therefore, preventing blocks for cell usage from being mixed like those detailed above improves the reliability of the entire memory.

In the first embodiment of the present invention, when the memory controller 22, as illustrated in FIG. 5, determines the range of blocks to be allocated to the SDA area and MDA area respectively, a few percent of the memory blocks are selected from both areas and registered as free blocks, where whether the SDA area or the MDA area is the area to be accessed is determined from a logic address, and a free block is selected by determining, from a memory block number, in which area the free block is included so as to select a free block corresponding to each area. Consequently, a memory block and a free block included in the SDA area are used only in the SDA area, while a memory block and a free block included in the MDA area are used only in the MDA area, which resolves the cell usage mixing issue. As a result, the reliability of the entire memory improves.

The block management method of the above-mentioned first embodiment will now be explained in detail with reference to the drawings.

FIG. 8 schematically illustrates the management of a memory block of the LBA-NAND memory of the first embodiment of the present invention.

First, a memory controller 22 divides a logic address space 50 into an MDA area 52 and an SDA area 51 with a command from an external source.

Next, the memory controller 22 determines a memory configuration of chips 0-N and also determines in which area each memory block is used during initialization, as illustrated in FIG. 5. At the same time, the memory controller 22 creates an L/P table 60 and an FB table 61.

The L/P table 60 is referred to while data are being written to a NAND flash memory 21. For example, in order to write binary data to a logic address “0x0002” in the SDA area 51, the L/P table 60 is referred to in order to write binary data to a memory block of a corresponding block address “chip 0, block number 0x0002” (hereinafter, the terms “chip” and “block number” are not mentioned). Similarly, in order to write multi-valued data to a logic address “0x2801” in the MDA area 52, the L/P table 60 is referred to and multi-valued data are written to a memory block of a corresponding block address “0, 0x0101.” This process is repeated for each initial writing process to a memory block registered to the L/P table 60.

Contrary to this, when an additional write command or a rewrite command such as a partial deletion is inputted from an external source to a memory block in which data have already been written, a memory block to be rewritten is replaced with a free block.

For example, when a write occurs in a logic address “0x0002” in the SDA area 51 in which data have been written, the memory controller 22 refers to a new block to be used from the FB table 61. At this time, the memory controller 22 determines from a command that the data to be written are binary data, confirms that the block address indicates a memory block included in the SDA area, as illustrated in FIG. 5, and selects a free block included in the SDA area, for example, a free block of block address “0, 0x0030.” Then the controller allocates a free block of block address “0, 0x0030” from the FB table 61 and replaces it with a memory block “0, 0x0002” in which a write occurred in the L/P table 60. Specifically, it reads out content in the memory block “0, 0x0002” and replaces a part of the content where a write occurs in order to write to a free block “0, 0x0030.” Then it erases the content in the memory block “0, 0x0002,” deletes this erased memory block from the L/P table 60 and adds it to the trailing edge of a queue in the FB table 61 and associates the free block “0, 0x0030” in which data are newly written with a logic address “0x0002” in the L/P table 60. In the FB table 61, the queue order is then incremented by one.

Similarly, when a write occurs in a logic address “0x2801” in which data have already been written in the MDA area 52, a new block to be used is referred to from the FB table 61. The memory controller 22 determines from a command that data to be written are multi-valued data, confirms that the block address is a memory block included in the MDA area, as illustrated in FIG. 5, and selects a free block included in the MDA area, for example, a free block of block address “N, 0x03FE.” Then it allocates the block address “N, 0x03FD” from the FB table 61 and replaces it with the memory block “0, 0x0101” in which a write occurred in the L/P table 60. Specifically, it reads out the content of a memory block “0, 0x0101,” replaces a part of the content in which the write occurred, and writes it into a free block “N, 0x03FE.” Then it erases the content of the memory block “0, 0x0101,” deletes this erased memory block from the L/P table 60 and adds it to the trailing edge of the queue in the FB table 61 as well as associating the free block “N, 0x03FE” in which data are newly written with a logic address “0x0101” in the L/P table 60. In the FB table 61, the queue order is then incremented by one.

The above operation is performed every time a block is rewritten.

According to the above-mentioned first embodiment, all block addresses in a chip are allocated to either the SDA area or the MDA area and whether a free block is used for storing binary data or multi-valued data is managed from a block address of the free block, which can prevent one block from being mixed for both binary data storage and multi-valued data storage. As a result, the reliability of a semiconductor memory device can be improved.

### [The Second Embodiment of Memory Block Management]

Next, the memory block management of a semiconductor memory device of the second embodiment of the present invention will be explained in detail with reference to the drawings.

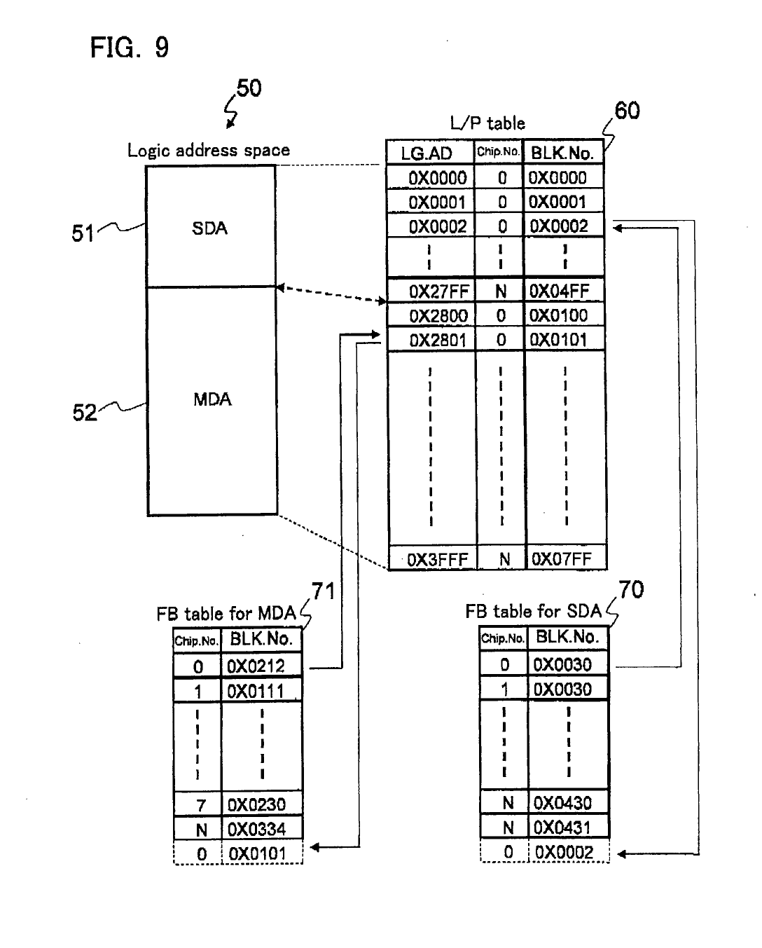

FIG. 9 schematically illustrates the management of a memory block of an LBA-NAND memory of the second embodiment of the present invention. The second embodiment is different from the first embodiment in that a free block table for storing binary data (hereinafter referred to as “an FB table for SDA”) 70 and a free block table for storing a multi-valued data (hereinafter referred to as “an FB table for MDA”) 71 are independently built without depending on a block address in a NAND flash memory chip. In the second embodiment, blocks for cell usage can be prevented from being mixed, and the reliability of a semiconductor memory can be improved. In FIG. 9, the same elements as used in the first embodiment illustrated in FIG. 8 are indicated by the same symbols and their explanation is therefore omitted.

In the second embodiment, during initialization, an FB table for SDA 70 and an FB table for MDA 71 are independently created at the same time as the L/P table 60. A few percent of all memory blocks are allocated as free blocks to be registered to these FB tables 70 and 71 without being registered to the L/P table 60. Those free blocks to be registered to the FB table for SDA 70 and the FB table for MDA 71 do not need to follow a memory block segmentation, as illustrated in FIG. 5. A case having one FB table for MDA 71 will be explained below as an example, but it should be appreciated that this example is not intended to be limiting in any way, as a plurality of FB tables for MDA corresponding to a 4-value, 8-value, 16-value, MDA or the like, for example, may be arranged.

The FB table for SDA 70 is a table for referring to an unused block for storing a binary data. A free block address for the SDA is entered in the FB table for SDA 70. A block, once entered to the FB table for SDA 70, is then replaced with a memory block in the SDA area 51, so it is never used as a block for storing multi-valued data.

The FB table for MDA 71 is a table for referring to an unused block for storing multi-valued data. A free block address for the MDA is then entered in the FB table for MDA 71. A block, once entered to the FB table for MDA 71, is then used as a block for storing multi-valued data and will be never used for storing binary data.

Next, an LBA-NAND memory block management method of the second embodiment will be explained in detail.

First, the memory controller 22 divides a logic address space 50 into an MDA area 52 and an SDA area 51 with a command from an external source. For example, logic addresses “0x0000” to “0x27FF” are allocated to the SDA area 51, while logic addresses “0x2800” to “0x3FFF” are allocated to the MDA area 52. It should be appreciated, however, that a logic address allocation method is not limited to this type of method only.

Next, the memory controller 22 builds an L/P table 60 during initialization, like that the first embodiment, and converts logic addresses in the SDA area 51 and the MDA area 52 to physical addresses with reference to the L/P table 60. Therefore, each cell in a NAND flash memory 21 can be accessed by an external device.

Either binary or multi-valued data are written to each cell in the NAND flash memory 21. For example, binary data are written to a block address “0, 0x0002” corresponding to a logic address “0x0002” in the SDA area 51. Similarly, multi-valued data are written to a block address “0, 0x0101” corresponding to a logic address “0x2801” in the MDA area 52. Any initial writing operation to a memory block registered in the L/P table 60 is repeated in this manner.

Contrary to this, when an additional write command or a rewrite command such as a partial deletion is inputted from an external source to a memory block in which data have already been written, a memory block to be rewritten is replaced with a free block.

For example, when a write occurs in a logic address “0x002” in the SDA area 51 in which data have been written, the memory controller 22 determines from a command that the data to be written are binary data, refers to a new block to be used from the FB table for SDA 70, and selects a free block, for example, a block having a block address “0, 0x0030.” Then, the controller allocates a free block of the selected block address “0, 0x0030” from the FB table for SDA 70 and replaces it with a memory block “0, 0x0002” in which the write occurred in the L/P table 60. Consequently, the controller 22 deletes the memory block “0, 0x0002” from the L/P table 60, adds it to the trailing edge of the queue in the FB table for SDA 70, and associates the free block “0, 0x0030” in which data are newly written with a logic address “0x0002” in the L/P table 60. In the FB table for SDA 70, the queue order in its free block addresses is then incremented by one.

Similarly, when a write occurs in a logic address “0x2801” in the MDA area 52 in which data have already been written, the memory controller 22 determines from a command that data to be written are multi-valued data, refers to a new block to be used from the FB table for MDA 71, and then, for example, selects a free block of a block address “0, 0x0212.” Then, the controller allocates a free block of the selected block address “0, 0x0212” from the FB table for MDA 71 and replaces it with a memory block “0, 0x0101” in which the write occurred in the L/P table 60. Consequently, the controller 22 deletes the memory block of a block address “0, 0x0101” from the L/P table 60, adds it to the trailing edge of the queue in the FB table for MDA 71, and associates a free block “0, 0x0212” in which data are newly written with a logic address “0x2801” in the L/P table 60. In the FB table for MDA 71, the queue order in the free block addresses is then incremented by one.

The above operation is performed every time binary data are written.

According to the second embodiment of the present invention, by building an FB table for binary value data and an FB table for multi-valued data independently and checking which table was referred to when a write occurred, blocks for cell usage can be prevented from being mixed. As a result, the reliability of a semiconductor memory device can be improved.

In addition, the block management of the above-mentioned first and second embodiments are explained as being controlled by an external memory controller 22 of a NAND flash memory 21, however, it should be appreciated that block management can be performed by a memory controller (firmware) inside the NAND flash memory 21, although this is not illustrated herein.

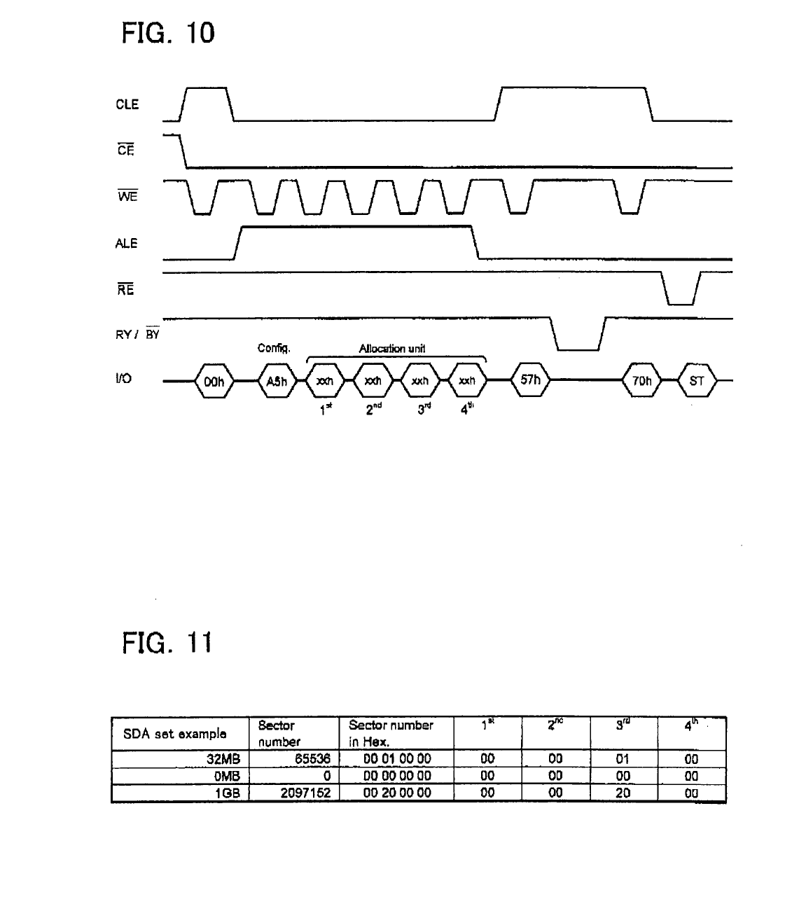

FIG. 10 is a timing chart for setting up a binary data storage area SDA which is provided externally.

In this instance, CLE indicates a command latch enable control signal, CE indicates a chip enable control signal, WE indicates a write enable control signal, ALE indicates an address latch enable control signal, RE indicates a read enable control signal, and RY/BY indicates a ready/busy control signal, respectively. At the time when a command is inputted, a read SDA command “00h” is read, and at the 5th cycle of the address latch, a set SDA command “A5h” and allocation units 1^{st}, 2^{nd}, 3^{rd}, and 4^{th} are inputted sequentially. The allocation unit, for example, as illustrated in FIG. 11, specifies the boundary position of a binary data storage area SDA. Consequently, the boundary area between an SDA and an MDA is set in the memory controller 22, and therefore further conversion processing between a logic address and a physical address is performed based on the specified boundary area.

It should be appreciated that the present invention is not limited to the above-mentioned embodiments. For example, in the above-mentioned embodiments, an LBA-NAND type memory is exemplified, but it should be appreciated that the present invention can be applied as an internal memory management system in a NAND type flash memory alone.

Furthermore, a memory in which the present invention is applied is not limited to one that uses a NAND type flash memory as its flash memory, and can also be applied to the case using a NOR type flash memory or other types of memory for performing similar memory management.

What is claimed is:

1. A semiconductor memory device, comprising:
a memory part which has a plurality of memory blocks having a memory cell capable of storing a plurality of different kinds of data which require a memory area having different characteristics; and
a memory controller which has a function of treating each of the memory blocks as a deletion unit in order to manage the memory part and converting a logic address of the memory part to a physical address identifying the memory block, and which replaces the memory block with a preregistered free block in rewriting the memory block,
wherein the memory controller manages the different kinds of data to be stored in the memory part so as to store the same kind of data as before, even after each of the memories and free blocks in the memory part are rewritten.

2. The semiconductor memory device according to claim 1,
wherein the memory controller builds a logic/physical address conversion table defining a corresponding relationship between a logic address of the memory part and a physical address of the memory block corresponding to the logic address, and refers to the logic/physical address conversion table in order to manage the different kinds of data to be stored in the memory part.

3. The semiconductor memory device according to claim 2,
wherein the memory controller configures a corresponding relationship between a memory area in the memory part and a memory block to be allocated to each memory area, and manages the different kinds of data to be stored in the memory part based on the corresponding relationship.

4. The semiconductor memory device according to claim 3,
wherein the memory controller registers to a free block table a memory block which is a part of the memory part as a free block, and when a written memory block in the memory part needs to be rewritten, the controller replaces the block to be rewritten with a free block included in the same memory area as the memory block to be rewritten, based on the corresponding relationship between the memory area and a memory block to be allocated to the memory area.

5. The semiconductor memory device according to claim 3,
wherein the memory controller registers a memory block which is a part of the memory part as a free block to a free block table which is arranged in each memory area, and when a written memory block in the memory part needs to be rewritten, the controller allocates a free block from a free block table which is the same kind as the data stored in a memory block which needs to be rewritten, and replaces it with the memory block which needs to be rewritten.

6. The semiconductor memory device according to claim 1, which includes binary data and multi-valued data in the different kinds of data.

7. The semiconductor memory device according to claim 1,
wherein the memory part includes a boot code block storing a boot code.

8. The semiconductor memory device according to claim 1,
wherein the memory part consists of a NAND type flash memory or a NOR type flash memory.

9. A semiconductor memory device comprising:
a memory part which has a plurality of memory blocks having a memory cell capable of storing data in a plurality of different kinds of writing/reading manners which require a memory area having different characteristics; and
a memory controller which has a function of treating each of the memory blocks as a deletion unit in order to manage the memory part and converting a logic address of the memory part to a physical address identifying the memory block, and which replaces the memory block with a preregistered free block in rewriting the memory block,
wherein the memory controller manages the different kinds of data to be stored in the memory part so as to store each of the memory blocks and free blocks in the memory part in the same writing and reading manner as before, even after rewriting.

10. The semiconductor memory device according to claim 9,
wherein the memory controller builds a logic/physical address conversion table defining a corresponding relationship between a logic address in the memory part and a physical address in the memory block corresponding to the logic address, and refers to the logic/physical address conversion table in order to store the different kinds of data to be stored in the memory part.

11. The semiconductor memory device according to claim 10,
wherein the memory controller configures a corresponding relationship between a memory area in the memory part and a memory block to be allocated to each memory block, and manages the different kinds of data to be stored in the memory part based on the corresponding relationship.

12. The semiconductor memory device according to claim 11,
wherein the memory controller registers to a free block table a memory block which is a part of the memory part as a free block, and when a written memory block in the memory part needs to be rewritten, the controller replaces the block to be rewritten with a free block included in the same memory area as the memory block to be rewritten based on the corresponding relationship between the memory area and a memory block to be allocated to the memory area.

13. The semiconductor memory device according to claim 11,
wherein the memory controller registers a memory block which is a part of the memory part as a free block to a free block table arranged in each memory area, and when a written memory block in the memory part needs to be rewritten, the controller allocates a free block from the same kind of free block table as the data stored in the memory block to be rewritten and replaces it with the memory block to be rewritten.

14. The semiconductor memory device according to claim 9, which includes binary data and multi-valued data in the different kinds of data.

15. A data management method using a semiconductor memory device, the device comprising:
a memory part which has a plurality of memory blocks having a memory cell capable of storing a plurality of different kinds of data which require a memory area having different characteristics; and
a memory controller which has a function of treating each of the memory blocks as a deletion unit in order to manage the memory part and converting a logic address of the memory part to a physical address identifying the memory block, and which replaces the memory block with a preregistered free block in rewriting the memory block,
wherein the different kinds of data to be stored in the memory part are managed by the memory controller so as to store the same kinds of data as before, even after each of the memory blocks and free blocks in the memory part are rewritten.

16. The data management method according to claim 15,
wherein a logic/physical address conversion table defining a corresponding relationship between a logic address of the memory part and a physical address of the memory block corresponding to the logic address is built, and the different kinds of data to be stored in the memory part are managed with reference to the logic/physical address conversion table by the memory controller.

17. The data management method according to claim 16,
wherein a corresponding relationship between a memory area in the memory part and a memory block allocated to each memory area are configured to manage the different kinds of data to be stored in the memory part based on the corresponding relationship by the memory controller.

18. The data management method according to claim 17,
wherein a memory block which is a part of the memory part is registered to a free block table as a free block and when a written memory block in the memory part needs to be rewritten, the block to be rewritten is replaced with the free block included in the same memory area as the memory block which needs to be rewritten based on the corresponding relationship between the memory area and a memory block to be allocated to a memory area by the memory controller.

19. The data management method according to claim 17,
wherein a memory block which is a part of the memory part is registered as a free block to a free block table arranged in each memory area, and when a written memory block in the memory part needs to be rewritten, a free block is allocated from the free block table which is the same kind as the data stored in the memory block to be rewritten, and replaced with the memory block to be rewritten by the memory controller.

20. The semiconductor memory device according to claim 15, which includes binary data and multi-valued data in the different kinds of data.
